(19) United States
(12) Patent Application Publication
(10) Pub. No.: US 2011/0248527 A1
(43) Pub. Date: Oct. 13, 2011

(54) ROOF SIDE STRUCTURE OF VEHICLE BODY

(75) Inventor: Takamasa ONO, Kanagawa (JP)

(73) Assignee: UNIPRES CORPORATION, Kanagawa (JP)

(21) Appl. No.: 13/080,256

(22) Filed: Apr. 5, 2011

(30) Foreign Application Priority Data
Apr. 9, 2010 (JP) 2010-090681

(51) Int. Cl. B62D 25/06

(52) U.S. Cl. 296/210

(57) ABSTRACT

Provided is a structure that ensures passenger space in the event of vehicle roll over and minimizes protrusion of the roof side portion, which has highly efficient load absorption and distribution, into the vehicle cabin, without sacrificing vehicle cabin space or requiring deep drawing press molding for increasing the section modulus of the roof side portion. A roof side rail has a closed cross section formed by connection flanges of an outer panel and an inner panel joining with each other, and a relationship between A, which is a product of a thickness and a yield point of the outer panel, and B, which is a product of a thickness and a yield point of the inner panel, satisfies A≦B.

### BACKGROUND

1. Technical Field

The present invention relates to a roof side structure in a vehicle body of an automobile. The contents of the following Japanese patent application are incorporated herein by reference,
No. 2010-090681 filed on Apr. 9, 2010.

2. Related Art

In order to ensure the safety of passengers when an automobile rolls over, the vehicle body must be structured to have a prescribed vehicle counterforce.

The conventional safety standards require that this vehicle counterforce be approximately 1.5 times the weight of the vehicle. Recently, however, automobile roll over is becoming more common, and therefore higher safety standards are expected from automobile development specifications. As a result, body strength is expected to reach 2.5 to 4 times the weight of the vehicle.

In order to ensure sufficient passenger space in the event of vehicle roll over while achieving the high standards described above, intrusion of the roof side portion into the passenger space is preferably minimized by increasing strength of the roof side portion.

In light of this, the technique described below is applied to a conventional vehicle roof side structure in which reinforcing members arranged lengthwise along the front to back direction of the vehicle are provided an the edges of the width of the vehicle roof panel, as described in Patent Document 1. This technique involves forming a low-strength portion in the roof side portion between a front pillar and a center pillar, and providing two load input points between deformation ends that are deformed inward to the vehicle cabin by a prescribed amount when a load is placed on the low-strength portion.

Accordingly, this technique prevents a focused load by spreading a load placed on the roof side portion to the two load input points, thereby causing the load to be placed on the front pillar and the center pillar.

### PRIOR ART DOCUMENTS

Patent Document 1: Japanese Patent Application Publication No. 2008-62713

However, with the conventional technique described above, the load placed on the roof side portion is spread to the two load input points provided as protruding convex portions to spread the load to the front pillar and center pillar to prevent a focused load, and deformation of the roof side portion is therefore minimized by decreasing the moment of the load on the roof side portion. Therefore, in order to achieve the above evaluation standard of withstanding a force that is 2.5 to 4 times the weight of the vehicle with the conventional technique, it is necessary to reserve space for the protruding portions to be provided on the roof side portion and to increase the section modulus to restrict deformation due to the load.

In order to increase the section modulus, the cross-sectional size of the roof side portion is increased, and this increase causes the roof side portion to protrude into the vehicle cabin, thereby sacrificing vehicle cabin space. Furthermore, this leads to a decrease in the size of the passenger doors and the need for deep drawing press molding.

Therefore, it is an object of the present invention to provide a structure that ensures passenger space in the event of vehicle roll over and minimizes protrusion of the roof side portion, which has highly efficient load absorption and distribution, into the vehicle cabin, without sacrificing vehicle cabin space or requiring deep drawing press molding for increasing the section modulus of the roof side portion.

### SUMMARY

The automobile roof side structure according to the present invention comprises a roof side rail as a reinforcing member providing support at a width-wise edge of a roof panel. The roof side rail includes an outer panel positioned on an outer side of a vehicle body and an inner panel positioned on an inner side of a vehicle cabin of the vehicle body, and the roof side rail is formed such that a relationship between A, which is a product of a thickness and a yield point of the outer panel, and B, which is a product of a thickness and a yield point of the inner panel, satisfies A≦B.

Accordingly, a portion of the load received by the roof side rail in a bending direction during automobile roll over is absorbed by the crushing deformation of the low-strength outer panel, and the remaining load is received by the bending counterforce of the high-strength inner panel. As a result, since the roof side rail absorbs the load applied during a roll over without bending, due to the bracing effect of the bending counterforce of the inner panel, a large burden is not placed on the pillar that serves as the initial point where the bracing effect begins.

Accordingly, a body strength can be achieved that fulfills the evaluation standard of withstanding 2.5 to 4 times the weight of the body, which is required when designing automobiles, without increasing the cross-sectional area of the roof side rail or the pillars to increase the section modulus.

Since cross-sectional area of the roof side rail and the pillars are not increased to increase the section modulus, no cabin space is sacrificed and the size of the passenger doors is not decreased. In addition, since the inner panel has high strength, the roof side rail provides sufficient protection in the event of a side-impact.

The relationship between A, which is the product of the thickness and the yield point of the outer panel, and B, which is the product of a thickness and the yield point of the inner panel, may satisfy A≦B as a result of the thickness of the inner panel being greater than the thickness of the outer panel.

With this structure, the inner panel can achieve higher strength than the outer panel, due to having a greater thickness.

The relationship between A, which is the product of the thickness and the yield point of the outer panel, and B, which is the product of a thickness and the yield point of the inner panel, may satisfy A≦B as a result of the inner panel being formed of a material whose yield point is higher than the yield point of the outer panel.

With this structure, the inner panel can achieve higher strength than the outer panel, due to using material with a higher yield point.

the relationship between A, which is the product of the thickness and the yield point of the outer panel, and B, which is the product of a thickness and the yield point of the inner panel, may satisfy A≦B as a result of a separate reinforcing structure being connected to the inner panel.

With this structure, the inner panel can achieve higher strength than the outer panel, due to having the separate reinforcing structure connected thereto.

The relationship between A, which is the product of the thickness and the yield point of the outer panel, and B, which is the product of a thickness and the yield point of the inner panel, may satisfy A≦B as a result of an inner panel bead, which has a convex or concave shape and extends in a front to back direction of the vehicle body, being formed integrally with the inner panel.

With this structure, the inner panel can achieve higher strength than the outer panel, due to restricting bending deformation by forming the inner panel bead, which has a convex or concave shape and extends in a front to back direction of the vehicle body, integrally with the inner panel.

The relationship between A, which is the product of the thickness and the yield point of the outer panel, and B, which is the product of a thickness and the yield point of the inner panel, may satisfy A≦B as a result of an outer panel bead, which has a convex or concave shape and extends in an up and down direction of the vehicle body, being formed integrally with the outer panel.

With this structure, the inner panel can achieve higher strength than the outer panel, due to promoting bending deformation by forming the outer panel bead integrally with the outer panel. The outer panel and the inner panel may each include a connection flange, and the roof side rail may have a closed cross section formed by connecting the connection flanges to each other. The roof side rail may be arranged across pillars that are positioned to be distanced from each other in the front to back direction of the automobile.

With the present invention, a portion of the load received by the roof side rail in a bending direction during automobile roll over is absorbed by the crushing deformation of the low-strength outer panel. The remaining load can be received by the bending counterforce of the high-strength inner panel. As a result, the roof side rail can absorb the load applied during a roll over without bending, due to the bracing effect of the bending counterforce of the inner panel, and a large burden is not placed on the pillar that serves as the initial point where the bracing effect begins.

Accordingly, a body strength can be achieved that fulfills the evaluation standard of withstanding 2.5 to 4 times the weight of the body, which is required when designing automobiles, without increasing the cross-sectional area of the roof side rail or the pillars to increase the section modulus. Since cross-sectional area of the roof side rail and the pillars are not increased, deep drawing press molding is unnecessary, no cabin space is sacrificed, and the size of the passenger doors is not decreased. In addition, since the inner panel has high strength, the roof side rail provides sufficient protection in the event of a side-impact.

### BRIEF DESCRIPTION OF THE DRAWINGS

FIG. 1 is a schematic perspective view of the vehicle body near the roof, when the present embodiment is applied to a passenger automobile.

FIG. 2 is an exploded perspective view of the vehicle body near the roof in FIG. 1.

FIG. 3 is a cross-sectional view along the line A-A in FIG. 1 of the First Embodiment.

FIG. 4 is a cross-sectional view along the line A-A in FIG. 1 of the Second Embodiment.

FIG. 5 is a cross-sectional view along the line A-A in FIG. 1 of the Third Embodiment.

FIG. 6 is a schematic perspective view of the inner panel in the Third Embodiment.

FIG. 7 is a cross-sectional view along the line A-A in FIG. 1 of the Fourth Embodiment.

FIG. 8 is a schematic perspective view of the outer panel in the Fourth Embodiment.

FIG. 9 is a cross-sectional view along the line A-A in FIG. 1 of the Fifth Embodiment.

### DESCRIPTION OF EXEMPLARY EMBODIMENTS

The roof side structure for an automobile according to the present embodiment absorbs the shock caused by automobile roll over by deformation of a low-strength outer panel side forming a roof side rail. The roof side structure of the automobile according to the present embodiment uses a high-strength inner panel side to generate a bending counterforce, which is the reformative force of the inner panel in response to a tensile force.

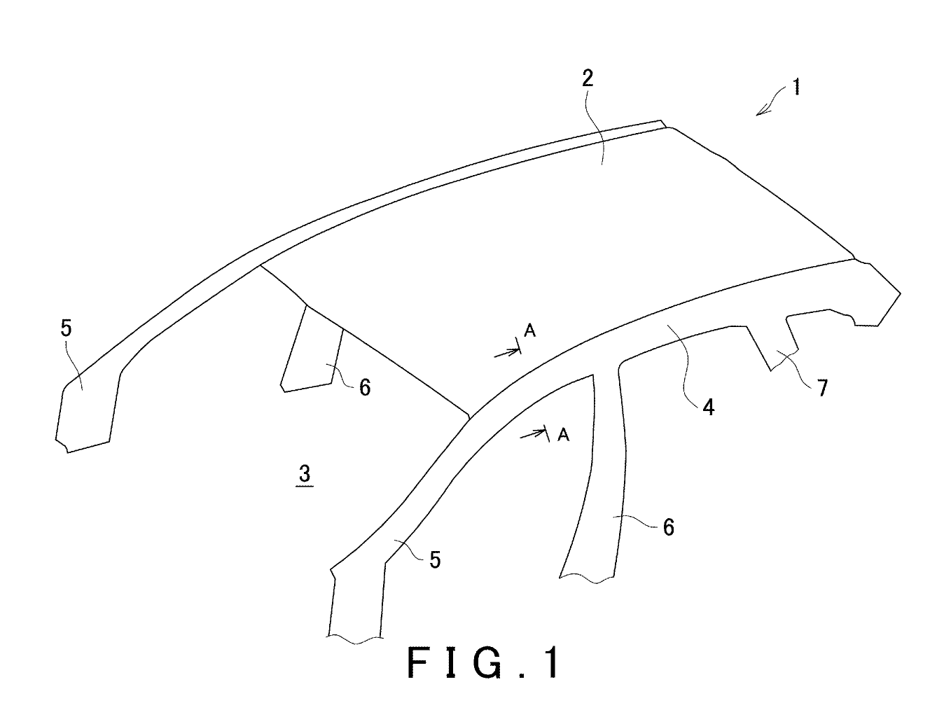

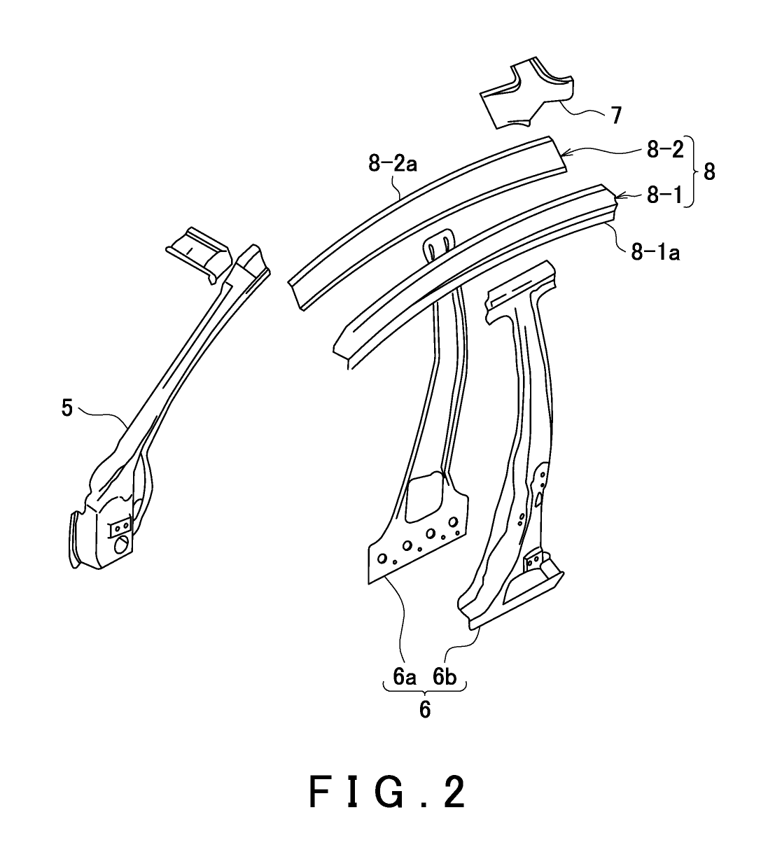

The following uses diagrams to describe examples obtained by applying the present embodiment to a passenger vehicle. In FIGS. 1 and 2, the vehicle body 1 of the automobile is shown as a roof panel 2 formed as the ceiling of a vehicle cabin 3. The roof panel 2 is supported by roof side portions 4 arranged along the width-wise edges of the automobile. The following describes a roof side portion 4 on one edge of the vehicle body 1, but the same description applies to the roof side portion 4 on the other side.

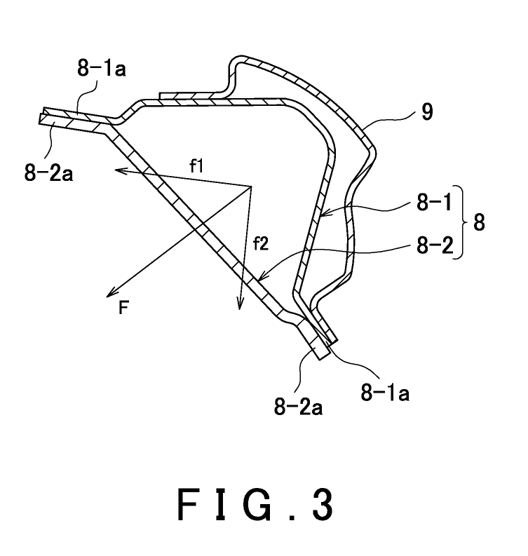

The roof side portion 4 is further supported by a front pillar 5, a center pillar 6, and a rear pillar 7 arranged sequentially from the front to the back of the automobile. The roof side portion 4 includes a roof side rail 8 whose length extends in the front to back direction of the vehicle body 1 and an outer plate 9 that is connected to cover the roof side rail 8 on the outside of the automobile, as shown in FIG. 3.

The roof side rail 8 includes an outer panel 8-1 positioned on the outside of the vehicle body 1 and an inner panel 8-2 positioned on the inside of the vehicle cabin 3. The roof side rail 8 has a closed cross section formed by a connection flange 8-1a of the outer panel 8-1 joining with a connection flange 8-2a of the inner panel 8-2. The outer panel 8-1 protrudes outward from the reinforcing material to form a substantially heart-shaped structure, and the inner panel 8-2 is provided inside the vehicle cabin to be substantially flat.

The center of the roof side rail 8 is sandwiched from inside and outside the automobile by an inner panel 6a and an outer panel 6b of the center pillar 6, and the ends of the roof side rail 8 are connected to the front pillar 5 and the rear pillar 7 to support the roof side rail 8.

In the First Embodiment described above, the roof side rail 8 is formed such that a relationship between A, which is the product of the thickness and the yield point of the outer panel 8-1, and B, which is the product of the thickness and the yield point of the inner panel 8-2, satisfies A≦B. Therefore, the outer panel 8-1 may be formed of steel plate material with a tensile strength of 590 MPa and a thickness of 1.0 mm, and the inner panel 8-2 may be formed of steel plate material with a tensile strength of 980 MPa and a thickness of 1.2 mm, for example.

Accordingly, in the roof side rail 8, the outer panel 8-1 side has low strength and the inner panel 8-2 side has high strength. As a result, when a load F is placed on the roof side rail 8 as the impact force during automobile roll over, the load F of the impact force is absorbed by the roof side rail 8 as a partial force f1 in the width direction of the vehicle body 1 and a partial force f2 in the up-down direction of the vehicle body 1.

The load F crushes the outer panel 8-1, which acts as a cushion due to its low strength, and is therefore decreased through absorption by this cushioning. The partial force f1, from the partial forces f1 and f2 in the decreased load F, operates as a bending force on the inner panel 8-2. This bending force is absorbed as a tensile counterforce, which is the restorative force of the inner panel 8-2, since the inner panel 8-2 has high strength. The partial force f2 is absorbed as a bending counterforce by the restorative force of the center pillar.

If the load generated by the automobile roll over becomes extremely high to the point where the load cannot be absorbed by the crushing of the outer panel 8-1 and the tensile force of the inner panel 8-2, a load is exerted on the front pillar 5, the center pillar 6, or the rear pillar 7. However, the load received by the front pillar 5, the center pillar 6, or the rear pillar 7 is only the remaining load that could not be absorbed by the roof side rail 8, and therefore the load that the front pillar 5, the center pillar 6, or the rear pillar 7 must absorb is decreased.

If the automobile is involved in a side-impact, even if the outer panel 8-1 has low strength, the load exerted by a side-impact can be sufficiently received by the inner panel 8-2 with high strength.

In the First Embodiment described above, the outer panel 8-1 and the inner panel 8-2 each have different thicknesses and different yield points such that A≦B, but the same effect can be achieved by selecting only one of the thickness and the yield point to have a different value.

With the structure described above, the load received as an impact force by the roof side rail 8 in the bending direction thereof during automobile roll over is absorbed as a result of the crushing deformation of the outer panel 8-1 with low strength. The partial force f2 can be received by the bending reaction force of the reformative force of the inner panel 8-2 with high strength. As a result, the roof side rail 8 achieves a bracing effect using the bending counterforce of the inner panel 8-2, and can absorb the load resulting from the impact force received during automobile roll over without breaking.

The load received by the front pillar 5, the center pillar 6, and the rear pillar 7 is the remaining load that was not absorbed by the roof side rail 8, and therefore the load that must be absorbed by the front pillar 5, the center pillar 6, or the rear pillar 7 is decreased. Accordingly, the roof side rail 8 and the pillar group including the front pillar 5, the center pillar 6, and the rear pillar 7 can fulfill the evaluation standards of withstanding 2.5 to 4 times the weight of the automobile, without increasing the section modulus by enlarging the cross-sectional size of the pillars.

The roof side rail 8 and the pillar group including the front pillar 5, the center pillar 6, and the rear pillar 7 do not have an enlarged cross-sectional size to increase the section modulus. Accordingly, the roof side rail 8 and this pillar group can be formed without using deep drawing press molding, and without sacrificing vehicle cabin space or decreasing the passenger door space.

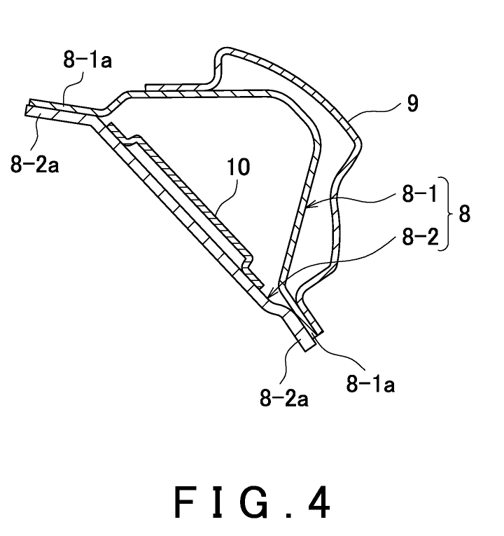

The following uses FIGS. 4 to 9 to describe another embodiment. In the Second Embodiment shown in FIG. 4, the inner panel 8-2 of the roof side rail 8 is formed using steel plate material whose thickness and crushing strength, i.e. yield point, are higher than those of the outer panel 8-1. Furthermore, a separate reinforcing material 10 is connected to the inner panel 8-2, and this reinforcing member 10 extends in the front to back direction of the vehicle 1 within the closed cross section of the inner panel 8-2.

With this configuration, the inner panel 8-2 can achieve high strength with respect to the outer panel by having the separate reinforcing material 10 connected thereto. Furthermore, with this configuration, the same effect can be achieved by using steel plate material having the same thickness and crush strength for both the inner panel 8-2 and the outer panel 8-1, and connecting the independent reinforcing material 10 to the inner panel 8-2.

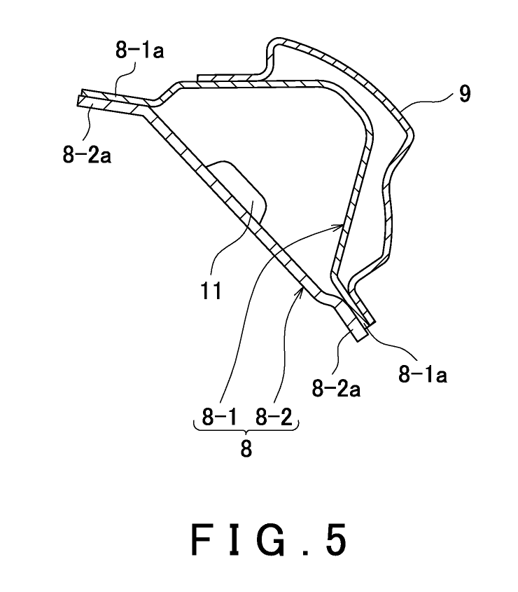

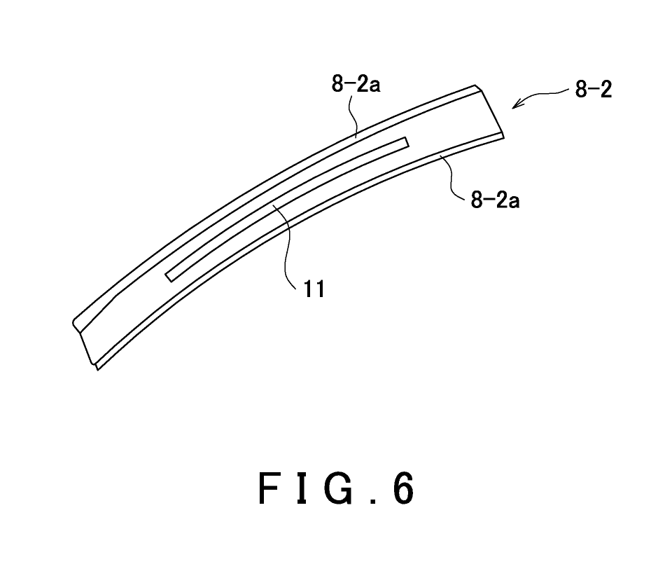

In a Third Embodiment shown in FIGS. 5 and 6, in order to achieve the A≦B structure described above, an inner panel bead 11, which has a convex shape protruding into the closed cross section and extends along the front to back direction of the vehicle body, is formed integrally on the inner panel 8-2. By forming the inner panel bead 11, which has a convex shape protruding into the closed cross section of the inner panel 8-2 and extends along the front to back direction of the vehicle body, integrally on the inner panel 8-2, the inner panel 8-2 can achieve high strength because the bending deformation is restricted.

In the Third Embodiment described above, the inner panel bead 11 formed integrally with the inner panel 8-2 may be formed with a concave shape in the closed cross section, and this type of inner panel bead 11 enables the inner panel 8-2 to achieve high strength by restricting the bending deformation, in the same manner as the convex inner panel bead 11.

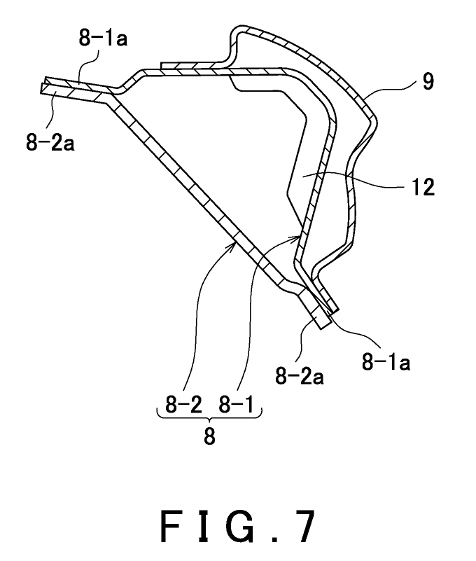

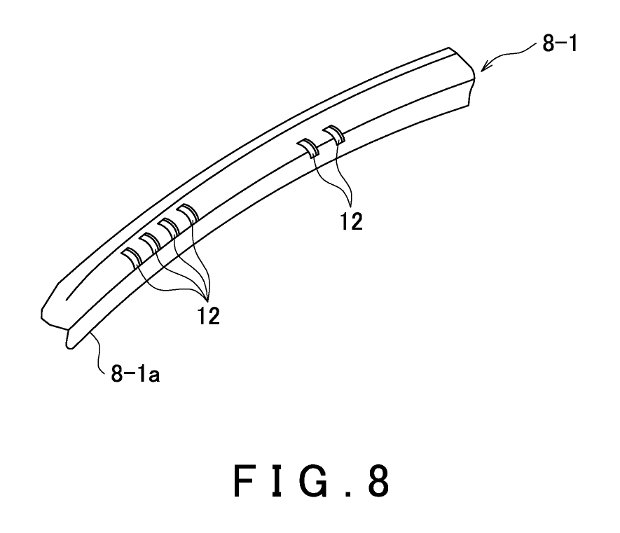

In the outer panel 8-1 according to a Fourth Embodiment shown in FIGS. 7 and 8, in order to achieve the A≦B structure described above, an outer panel bead 12, which has a convex shape protruding into the closed cross section and extends along the up and down direction of the vehicle body, is formed integrally on the outer panel 8-1. With this configuration, the inclusion of the outer panel bead 12 formed integrally with the outer panel 8-1 promotes the bending deformation, and as a result, the outer panel 8-1 becomes a structure with low strength.

In the Fourth Embodiment, the outer panel bead 12 may be formed with a concave shape in the closed cross section, and this type of outer panel bead 12 enables the outer panel 8-1 to achieve low strength by promoting the bending deformation, in the same manner as the convex outer panel bead 12.

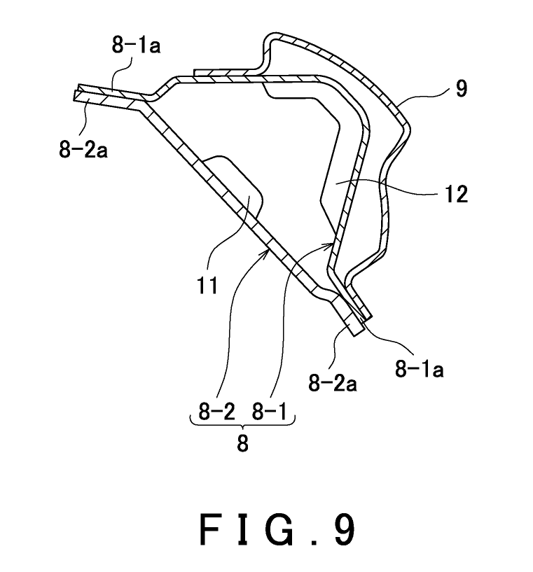

A Fifth Embodiment shown in FIG. 9 is essentially a combination of the Third Embodiment shown in FIGS. 5 and 6 and the Fourth Embodiment shown in FIGS. 7 and 8. Accordingly, the inclusion of the inner panel bead 11 restricts the bending deformation of the inner panel 8-2, and the inclusion of the outer panel bead 12 promotes the bending deformation of the outer panel 8-1.

As a result, a structure is obtained in which the relationship between A, which is the product of the thickness and the yield point of the outer panel 8-1, and B, which is the product of the thickness and the yield point of the inner panel 8-2, satisfies A≦B, as described above. In this case, as in the First Embodiment, the outer panel 8-1 may be formed of steel plate material with a tensile strength of 590 MPa and a thickness of 1.0 mm, and the inner panel 8-2 may be formed of steel plate material with a crushing strength, i.e. yield point, of 980 MPa and a thickness of 1.2 mm, for example.

The above First through Fifth Embodiments each describe an example n which each of the front pillar 5, the center pillar 6, and the rear pillar 7, suitable for a passenger vehicle, were used as the pillar group, but the roof side structure of the present invention can be applied to a truck or the like that does not include the center pillar 6.

The embodiments described above can be used to achieve a structure that increases strength of a roof side portion to decrease deformation of the roof side portion, by increasing the section modulus of the pillar group while ensuring passenger space in the event of automobile roll over and without using deep drawing press molding.

What is claimed is:

1. A roof side structure of a vehicle body comprising a roof side rail as a reinforcing member at a width-wise edge of a roof panel, wherein
the roof side rail includes an outer panel positioned on an outer side of a vehicle body and an inner panel positioned on an inner side of a vehicle cabin of the vehicle body, and
the roof side rail is formed such that a relationship between A, which is a product of a thickness and a yield point of the outer panel, and B, which is a product of a thickness and a yield point of the inner panel, satisfies A≦B.

2. The roof side structure of a vehicle body according to claim 1, wherein
the relationship between A, which is the product of the thickness and the yield point of the outer panel, and B, which is the product of a thickness and the yield point of the inner panel, satisfies A≦B as a result of the thickness of the inner panel being greater than the thickness of the outer panel.

3. The roof side structure of a vehicle body according to claim 1, wherein
the relationship between A, which is the product of the thickness and the yield point of the outer panel, and B, which is the product of a thickness and the yield point of the inner panel, satisfies A≦B as a result of the inner panel being formed of a material whose yield point is higher than the yield point of the outer panel.

4. The roof side structure of a vehicle body according to claim 1, wherein
the relationship between A, which is the product of the thickness and the yield point of the outer panel, and B, which is the product of a thickness and the yield point of the inner panel, satisfies A≦B as a result of a separate reinforcing structure being connected to the inner panel.

5. The roof side structure of a vehicle body according to claim 1, wherein
the relationship between A, which is the product of the thickness and the yield point of the outer panel, and B, which is the product of a thickness and the yield point of the inner panel, satisfies A≦B as a result of an inner panel bead, which has a convex or concave shape and extends in a front to back direction of the vehicle body, being formed integrally with the inner panel.

6. The roof side structure of a vehicle body according to claim 1, wherein
the relationship between A, which is the product of the thickness and the yield point of the outer panel, and B, which is the product of a thickness and the yield point of the inner panel, satisfies A≦B as a result of an outer panel bead, which has a convex or concave shape and extends in an up and down direction of the vehicle body, being formed integrally with the outer panel.

7. The roof side structure of a vehicle body according to claim 1, wherein
the outer panel and the inner panel each include a connection flange, and
the roof side rail has a closed cross section formed by connecting the connection flanges to each other.

8. The roof side structure of a vehicle body according to claim 1, wherein
the roof side rail is arranged across pillars that are positioned to be distanced from each other in the front to back direction of the automobile.
